(19) United States
(12) Patent Application Publication
(10) Pub. No.: US 2013/0342568 A1
(43) Pub. Date: Dec. 26, 2013

(54) LOW LIGHT SCENE AUGMENTATION

(71) Applicants: Tony Ambrus, Seattle, WA (US); Mike Scavezze, Bellevue, WA (US); Stephen Latta, Seattle, WA (US); Daniel McCulloch, Kirkland, WA (US); Brian Mount, Seattle, WA (US)

(72) Inventors: Tony Ambrus, Seattle, WA (US); Mike Scavezze, Bellevue, WA (US); Stephen Latta, Seattle, WA (US); Daniel McCulloch, Kirkland, WA (US); Brian Mount, Seattle, WA (US)

(21) Appl. No.: 13/528,523

(22) Filed: Jun. 20, 2012

(51) Int. Cl. G09G 5/00

(52) U.S. Cl. 345/633

(57) ABSTRACT

Embodiments related to providing low light scene augmentation are disclosed. One embodiment provides, on a computing device comprising a see-through display device, a method including recognizing, from image data received from an image sensor, a background scene of an environment viewable through the see-through display device, the environment comprising a physical object. The method further includes identifying one or more geometrical features of the physical object and displaying, on the see through display device, an image augmenting the one or more geometrical features.

### BACKGROUND

Navigating through rooms and other locations that may be well-known and/or easily navigable in normal lighting conditions may be difficult and potentially hazardous in low light conditions. However, turning on lights or otherwise modifying the environment may not always be possible or desirable. For example, power failures that occur during nighttime may prohibit the use of room lighting. Likewise, it may be undesirable to turn on lights when others are sleeping.

As such, various devices may be used to assist in navigating low light environments, such as night vision goggles. Night vision goggles amplify detected ambient light, and thus provide visual information in low light environments.

### SUMMARY

Embodiments are disclosed that relate to augmenting an appearance of a low light environment. For example, one disclosed embodiment provides, on a computing device comprising a see-through display device, a method comprising recognizing, from image data received from an image sensor, a background scene of an environment viewable through the see-through display device, the environment comprising a physical object. The method further comprises identifying one or more geometrical features of the physical object and displaying, on the see through display device, an image augmenting the one or more geometrical features.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an example use environment for an embodiment of a see-through display device, and also illustrates an embodiment of an augmentation of a view of a low light scene by the see-through display device.

FIG. 2 illustrates another embodiment of an augmentation of a view of a low light scene by the see-through display device of FIG. 1.

FIG. 3 schematically a block diagram illustrating an embodiment of a use environment for a see-through display device configured to provide low light scene augmentation.

FIG. 4 shows a process flow depicting an embodiment of a method for augmenting a view of a low light scene.

FIG. 5 schematically shows an example embodiment of a computing system.

### DETAILED DESCRIPTION

As mentioned above, humans may have difficulty in navigating through locations that are well known and easily navigable in normal lighting conditions. At times, external visible light sources (e.g., room lighting, moonlight, etc.) may help to alleviate such issues. However, such light sources may not always be practical and/or usable.

Various solutions have been proposed in the past to facilitate navigating low light environments, including but not limited to night vision devices such as night vision goggles. However, night vision devices may function as “dumb” devices that merely amplify ambient light. As such, the resulting image may have a grainy appearance that may not provide a suitable amount of information in some environments.

Thus, embodiments are disclosed herein that relate to aiding user navigation in low light environments by augmenting the appearance of the environment, for example, by outlining edges and/or alerting the user to potential hazards (e.g., pets, toys, etc.) that may have otherwise gone unnoticed. In this way, a user may be able to safely and accurately navigate the low light environment.

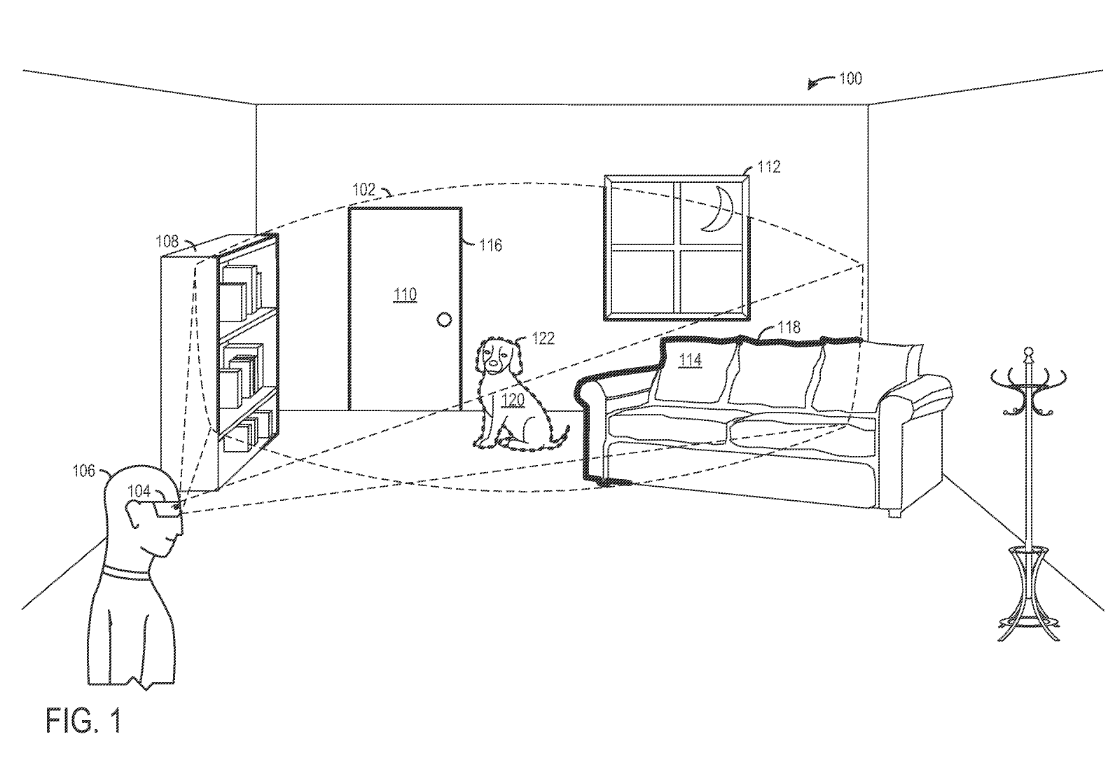

Prior to discussing these embodiments in detail, a non-limiting use scenario is described with reference to FIG. 1. More particularly, FIG. 1 illustrates an example of a low light environment 100 in the form of a living room. The living room comprises a background scene 102 viewable through a see-through display device 104 worn by user 106 is shown in FIG. 1. As used herein, “background scene” refers to the portion of the environment viewable through the see-through display device 104 and thus the portion of the environment that may be augmented with images displayed via the see-through display device 104. For example, in some embodiments, the background scene may be substantially coextensive with the user's field of vision, while in other embodiments the background scene may occupy a portion of the user's field of vision.

As will be described in greater detail below, see-through display device 104 may comprise one or more outwardly facing image sensors (e.g., two-dimensional cameras and/or depth cameras) configured to acquire image data (e.g. color/grayscale images, depth images/point cloud data, etc.) representing environment 100 as the user navigates the environment. This image data may be used to obtain information regarding the layout of the environment (e.g., three-dimensional surface map, etc.) and objects contained therein, such as bookcase 108, door, 110, window 112, and sofa 114.

The image data acquired via the outwardly facing image sensors may be used to recognize a user's location and orientation within the room. For example, one or more feature points in the room may be recognized by comparison to one or more previously-acquired images to determine the orientation and/or location of the see-through display device in the room.

The image data may be further used to recognize one or more geometrical features (e.g., edges, corners, etc.) of the physical objects for visual augmentation via the see-through display device. For example, the see-through display device 104 may display an image comprising a highlight, such as an outline and/or shading, in spatial registration with one or more geometrical features, such as edges and/or corners, of the physical objects. The displayed highlights may have any suitable appearance. For example, in some embodiments, the displayed highlights may have a uniform appearance, such as a line of uniform width, for all geometrical features. In other embodiments, the appearance of the highlight may be based on one or more physical characteristics of a geometrical feature, for example, to accentuate the particular nature of the geometrical feature. For example, as illustrated, a highlight 116 of door 110 is thinner than a highlight 118 of sofa 114 to illustrate a greater depth differential between sofa 114 and the surrounding environment as compared to that between door 110 and its surrounding environment. As another example, a thickness of the outline may be inversely proportional to the depth difference, or may have any other suitable relationship relative to the geometric feature.

Although illustrated in FIG. 1 as a solid outline coextensive with the edges of a physical object, it will be appreciated that the term “highlight” as used herein refers to any visual augmentation of an object configured to aid a user in seeing and understanding the object in low light conditions. The visual augmentation may comprise any suitable configuration on a per-object basis, a per-environment basis, and/or according to any other granularity or combination of granularities. Further, said configuration may be programmatically-determined and/or user-defined and/or user-adjusted. The visual augmentation may comprise any suitable color, shape, thickness, and/or style (e.g., dashed line, double line, edge “glowing edges”, etc.). As another example, augmentations may be selectively enabled or disabled. It will be understood that the above scenarios are presented for the purpose of example, and are not intended to be limiting in any manner.

It will further be understood that other suitable information may be displayed to assist a user navigating a low light environment. For example, in some embodiments, a user may be explicitly guided around obstacles with some form of displayed navigational directions, such as lines, beacons and/or arrows configured to direct a user through spaces between objects, if the room has been previously mapped.

The image data and/or information computed therefrom may be stored to assist in future navigation of the environment. For example, as mentioned above and discussed in greater detail below, previously-collected image data may be used to determine a orientation and location of the user by comparison with image data being collected in real-time, and may therefore be used to assist in determining an augmented reality image for display. Further, image data may be gathered as user 106 and/or other users navigate environment 100 during daytime or other “normal” lighting conditions. This may allow image data, such as a color image representation of environment 100, acquired during normal light navigation to be displayed via device 104 during low light scenarios. Likewise, depth image data acquired during normal light conditions may be used to render a virtual representation of the environment during low-light conditions.

Further, previously-collected image data may be used to identify one or more dynamic physical objects, an example of which is illustrated in FIG. 1 as a dog 120. The term “dynamic physical object” refers to any object not present, or not present in the same location, during a previous acquisition of image data. As the position of dynamic physical objects changes over time, these objects may present a greater hazard when navigating during low light scenarios. Accordingly, in some embodiments, the highlighting of dynamic physical objects (e.g., highlight 122 of dog 120) may comprise a different appearance than the highlighting of physical objects (e.g., highlights 116 and 118). For example, as illustrated, highlight 122 comprises a dashed outline in spatial registration with dog 116. In other embodiments, highlight 122 may comprise any other suitable appearance (e.g. different color, brightness, thickness, additional imagery) that distinguishes dog 120 from the remainder of background scene 102.

In some embodiments, information instead of, or in addition to, the image data may be used to identify the one or more dynamic physical objects. For example, in some embodiments, one or more audio sensors (e.g., microphones) may be configured to acquire audio information representing the environment. The audio information may be usable to identify a three-dimensional location of one or more sound sources (e.g., dog 120, other user, television, etc.) within the environment. Accordingly, such three-dimensional locations that do not correspond to one or more physical objects may be identified as dynamic physical objects. Such mechanisms may be useful, for example, when image data is not usable to identify one or more dynamic physical objects (e.g., light level below capabilities of image sensors, obstruction between image sensors and dynamic physical object, etc.). Further, in some embodiments, one or more characteristics of the dynamic physical object (e.g., human vs. animal, etc.) may be determined based on the audio information.

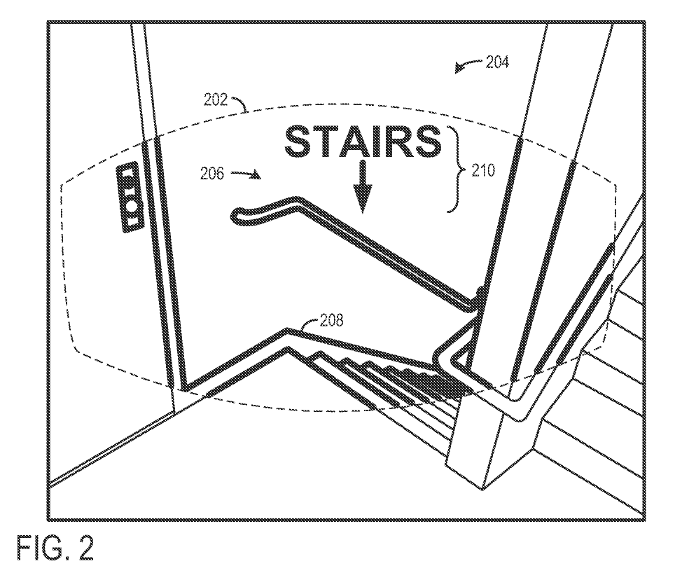

In some embodiments, additional information other than highlighting may be displayed on a see-through display device to help a user navigate a low light environment. For example, FIG. 2 shows an example embodiment of a background scene 202 within an environment 204 as viewed through a see-through display device. Environment 204 comprises a physical object 206 in the form of a staircase, and illustrates highlighting 208 displayed over the stairs via the see-through display device to augment the user's view of the stairs. Further, the see-through display device further augments the user's view by display of a tag 210, illustrated as an arrow and the word “STAIRS” in text, to provide additional information regarding the object. Such tags may be associated with objects to show previously-identified hazards (e.g., stairs), areas or objects of interest (e.g., refrigerator, land-line telephone, etc.), and/or any other suitable objects and/or features. Further, in some embodiments, tags may be associated with dynamic physical objects. It will be understood that tags may be defined programmatically (e.g. by classifying objects detected in image data and applying predefined tags to identified objects) and/or via user input (e.g. by receiving a user input identifying an object and a desired tag for the object). It will be appreciated that tags may have any suitable appearance and comprise any suitable information.

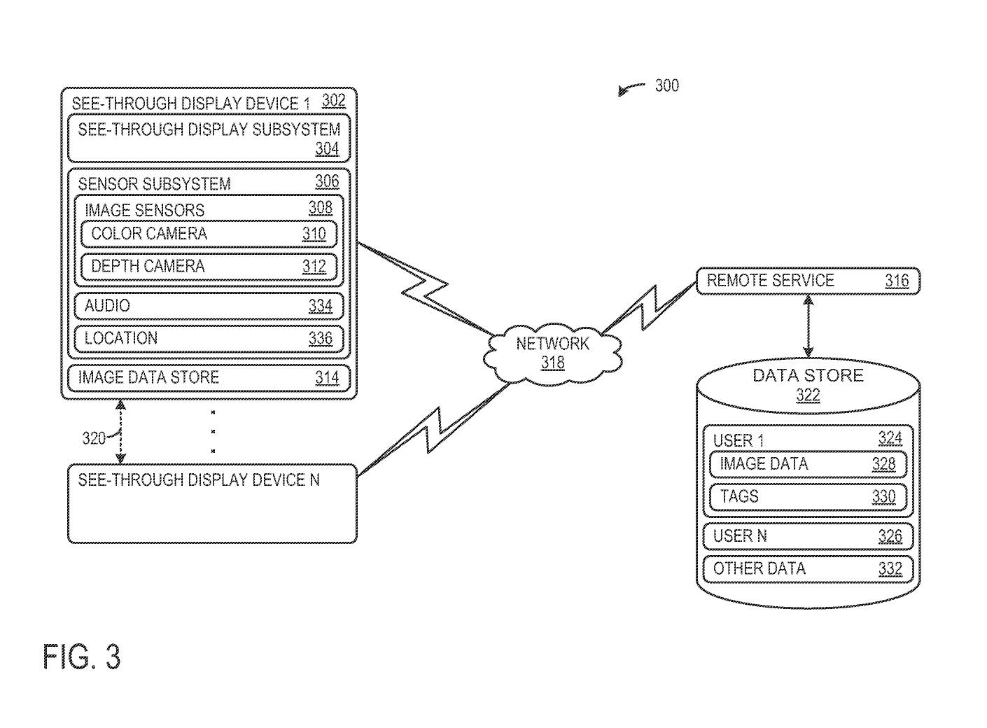

FIG. 3 schematically shows an embodiment of a use environment 300 for a see-through display device configured to visually augment low light scenes. Use environment 300 comprises a plurality of see-through display devices, illustrated as see-through display device 1 302 and see-through display device N. Each see-through display device comprises a see-through display subsystem 304. The see-through display devices may take any suitable form, including but not limited to head-mounted near-eye displays in the form of eyeglasses, visors, etc. As mentioned above, the see-through display subsystem 304 may be configured to display an image augmenting an appearance of geometrical features of physical objects.

Each see-through display device 302 may further comprise a sensor subsystem 306. The sensor subsystem 306 may comprise any suitable sensors. For example, the sensor subsystem 306 may comprise one or more image sensors 308, such as, for example, one or more color (or grayscale) two-dimensional cameras 310 and/or one or more depth cameras 312. The depth cameras 312 may be configured to measure depth using any suitable technique, including, but not limited to, time-of-flight, structured light, or stereo imaging. Generally, the image sensors 308 may comprise one or more outward-facing cameras configured to acquire image data of a background scene (e.g., scene 102 of FIG. 1) viewable through the see-through display device. Further, in some embodiments, the user device may include one or more illumination devices (e.g., IR LEDs, flash, structured light emitters, etc.) to augment image acquisition. Such illumination devices may be activated in response to one or more environmental inputs (e.g., low light detection) and/or one or more user inputs (e.g., voice command). In some embodiments, the image sensors may further comprise one or more inward-facing image sensors configured to detect eye position and movement to enable gaze tracking (e.g., to allow for visual operation of a menu system, etc.).

The image data received from image sensors 308 may be stored in an image data store 314 (e.g., FLASH, EEPROM, etc.), and may be usable by see-through display device 302 to identify the physical objects and dynamic physical objects present in a given environment. Further, each see-through display device 302 may be configured to interact with a remote service 316 and/or one or more other see-through display devices via a network 318, such as a computer network and/or a wireless telephone network. Further, in some embodiments, interaction between see-through display devices may be provided via a direct link 320 (e.g., near-field communication) instead of, or in addition to, via network 318.

The remote service 316 may be configured to communicate with a plurality of see-through display devices to receive data from and send data to the see-through display devices. Further, in some embodiments, at least part of the above-described functionality may be provided by the remote service 316. As a non-limiting example, the see-through display device 302 may be configured to acquire image data and display the augmented image, whereas the remaining functionality (e.g., object identification, image augmentation, etc.) may be performed by the remote service.

The remote service 316 may be communicatively coupled to data store 322, which is illustrated as storing information for a plurality of users represented by user 1 324 and user N 326. It will be appreciated that any suitable data may be stored, including, but not limited to, image data 328 (e.g. image data received from image sensors 308 and/or information computed therefrom) and tags 330 (e.g., tag 210). In some embodiments, data store 322 may further comprise other data 332. For example, other data 332 may comprise information regarding trusted other users with whom image data 328 and/or tags 330 may be shared. In this way, a user of device 302 may be able to access data that was previously collected by one or more different devices, such as a see-through display device or other image sensing device of a family member. As such, the image data and/or information computed therefrom related to various use environments may be shared and updated between the user devices. Thus, depending upon privacy settings, a user may have access to a wide variety of information (e.g., information regarding the layout, tags, etc.) even if the user has not previously navigated an environment.

The see-through display device 302 may further comprise one or more audio sensors 334, such as one or more microphones, which may be used as an input mechanism, as discussed in greater detail below. Audio sensors 334 may be further configured to identify one or more dynamic physical objects, as mentioned above. The see-through display device 302 may further comprise one or more location sensors 336 (e.g., GPS, RFID, proximity, etc.). In some embodiments, the location sensors may be configured to provide data for determining a location of the user device. Further, in some embodiments, information from one or more wireless communication devices may be usable to determine location, for example, via detection of proximity to known wireless networks.

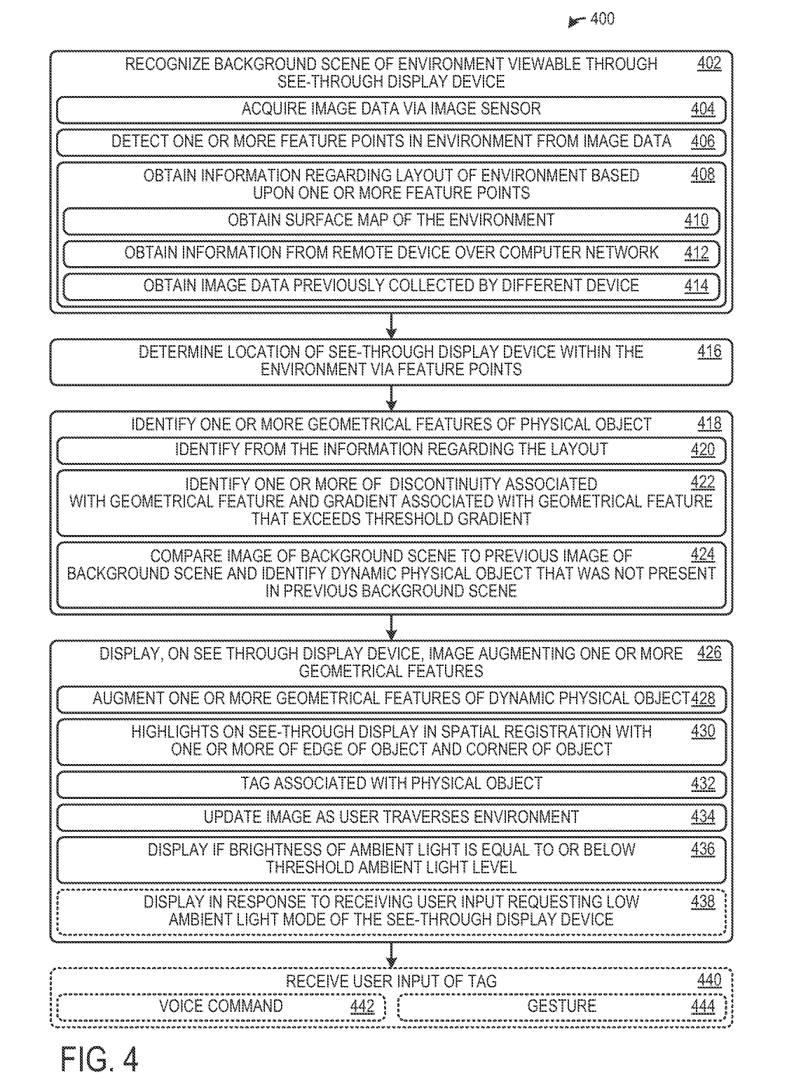

FIG. 4 shows a flow diagram depicting an embodiment of a method 400 for providing visual augmentation of a low light environment. Method 400 comprises, at 402, recognizing a background scene of an environment viewable through a see-through display device, wherein the environment may comprise one or more physical objects and/or one or more dynamic physical objects. Recognizing the background scene may comprise acquiring 404 image data via an image sensor, such as color camera(s) and/or depth camera(s), and may further comprise detecting 406 one or more feature points in the environment from the image data.

Recognizing the background scene may further comprise obtaining 408 information regarding a layout of the environment based upon the one or more feature points. For example, obtaining information regarding the layout may comprise obtaining 410 a surface map of the environment. As mentioned above in reference to FIG. 3, such information may be obtained locally (e.g., via image sensors 308 and/or image data store 314) and/or may be obtained 412 from a remote device over a computer network (e.g., data store 322, other user device, etc.). In some embodiments, such information retrieved from the remote device may have been captured by the requesting computing device during previous navigation of the environment. Likewise, the image data obtained from the remote device may comprise image data previously collected by a device other than the requesting computing device, such as a computing device of a friend or family member.

At 416, method 400 comprises determining a location of the see-through display device within the environment via the feature points. In some embodiments, such a determination may be further performed via data from one or more location sensors (e.g., location sensors 336).

Method 400 further comprises, at 418, identifying one or more geometrical features of one or more physical objects. In some embodiments, such identification may be provided from the information regarding the layout at 420 (e.g., real-time and/or previously-collected information). For example, in some embodiments, identifying the one or more geometrical features may comprise identifying 422 one or more of a discontinuity associated with the geometrical feature and a gradient associated with the geometrical feature that exceeds a threshold gradient. Such depth characteristics may be determined, for example, via one or more depth cameras (e.g., depth camera 312), via stereo cameras, or via any one or more suitable depth sensors.

Identifying one or more geometrical features of one or more physical objects may further comprise comparing 424 an image of the background scene received from an image sensor (e.g., image sensors 308 of FIG. 3) to a previous image of the background scene and identifying one or more dynamic physical objects (e.g., dog 120 of FIG. 1) that were not present in the previous background scene. As mentioned above, dynamic physical objects may also include objects that were present in the previously-collected data, but which have since changed position (e.g., toys, furniture, etc.).

At 426, method 400 comprises displaying, on the see through display device, an image augmenting one or more geometrical features. The image also may augment 428 geometrical features of one or more dynamic physical objects, which as mentioned above, may comprise a same or different appearance than the augmentation of the physical objects. As described above, augmentation of a physical object or a dynamic physical object may comprise, for example, displaying 430 highlights on the see-through display in spatial registration with one or more of an edge of an object and a corner of the object. Alternatively or additionally, in some embodiments, an augmentation of the object may include image features not in spatial registration with one or more geometrical features of the object, such as a geometric shape (ellipse, polygon, etc.) shown around object. It will be understood that these scenarios are presented for the purpose of example, and that an appearance of physical objects may be augmented in any suitable manner without departing from the scope of the present disclosure.

1. Augmenting the appearance of physical objects may further comprise displaying 432 one or more tags associated with one or more corresponding physical objects and/or with one or more corresponding dynamic physical objects. Displaying the image may further comprise updating 434 the image as the user traverses the environment. For example, the image may be updated such that the highlighting remains in spatial registration with the objects consistent with the current perspective of the user. Updating may be performed in any suitable manner. For example, updating may comprise generating a three-dimensional representation of a use environment comprising the background scene (e.g. from point cloud data), tracking motion of the see through display device within the use environment (e.g. by image and/or motion sensors), and updating the image based upon the tracking of the motion and the three-dimensional representation of the use environment.

The display of images to augment a low light environment may be triggered in any suitable manner. For example, in some embodiments, method 400 may comprise displaying 436 the image if brightness of ambient light meets a threshold condition (e.g. is equal to or below a threshold ambient light level). In such embodiments, an ambient light level may be detected via image data acquired from the image sensors. Further, the threshold ambient light level may be pre-defined and/or may be user-adjustable. As another example, low light scene augmentation may be triggered based on the current date and/or time. In yet other embodiments, low light scene augmentation may be triggered via a user input requesting operation in a low light augmentation mode. As such, method 400 may comprise displaying 438 the image in response to receiving user input requesting a low ambient light mode of the see-through display device. Such a user input may be received in any suitable manner. Examples include, but are not limited to, speech inputs, tactile (e.g., touch screen, buttons, etc.) inputs, gesture inputs (e.g., hand gesture detectable via the image sensors), and/or gaze-based inputs.

As discussed above, tags may be used to provide additional information regarding objects. Tags may be assigned to objects in any suitable manner. For example, in some embodiments, tags may be defined programmatically via pattern recognition or other computer-vision techniques. As a more specific example, one or more tags (e.g., “Look Out!”) may be programmatically associated with a dynamic physical object. As another example, stairs 206 of FIG. 2 may be recognized as stairs (e.g. by classification), and a tag of “stairs” (e.g., tag 210) may be programmatically associated therewith.

Further, in some embodiments, a tag may be assigned via a user input assigning a tag to an object, as indicated at 440. A user input assigning a tag may be made in any suitable manner. For example, a user may point at or touch an object and assign a tag to the object via a voice command. In such an example, the object may be identified by image data capturing the pointing and/or touching gesture, and the content of the tag may be identified by speech analysis. In other embodiments, gaze detection may be used to determine an object to be tagged. As yet another example, tagging may be effected by pointing a mobile device (e.g., phone) towards an object to be tagged (e.g., by recognizing orientation information provided by the mobile device). It will be understood that these examples of methods of tagging an object for low light augmentation are presented for the purpose of example, and are not intended to be limiting in any manner.

In some embodiments, the above described methods and processes may be tied to a computing system including one or more computers. In particular, the methods and processes described herein may be implemented as a computer application, computer service, computer API, computer library, and/or other computer program product.

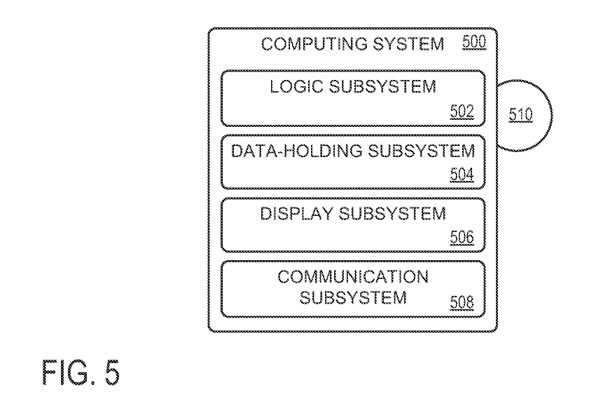

FIG. 5 schematically shows a nonlimiting computing system 500 that may perform one or more of the above described methods and processes. See-through display device 104, see-through display device 302, and remote service 316 are non-limiting examples of computing system 500. Computing system 500 is shown in simplified form. It is to be understood that virtually any computer architecture may be used without departing from the scope of this disclosure. In different embodiments, computing system 500 may take the form of a mainframe computer, server computer, desktop computer, laptop computer, tablet computer, home entertainment computer, wearable computer, see-through display device, network computing device, mobile computing device, mobile communication device, gaming device, etc.

Computing system 500 includes a logic subsystem 502 and a data-holding subsystem 504. Computing system 500 may optionally include a display subsystem 506, communication subsystem 508, and/or other components not shown in FIG. 5. Computing system 500 may also optionally include user input devices such as keyboards, mice, game controllers, cameras, microphones, and/or touch screens, for example.

Logic subsystem 502 may include one or more physical devices configured to execute one or more instructions. For example, logic subsystem 502 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 502 may include one or more processors that are configured to execute software instructions. Additionally or alternatively, logic subsystem 502 may include one or more hardware or firmware logic machines configured to execute hardware or firmware instructions. Processors of logic subsystem 502 may be single core or multicore, and the programs executed thereon may be configured for parallel or distributed processing. Logic subsystem 502 may optionally include individual components that are distributed throughout two or more devices, which may be remotely located and/or configured for coordinated processing. One or more aspects of logic subsystem 502 may be virtualized and executed by remotely accessible networked computing devices configured in a cloud computing configuration.

Data-holding subsystem 504 may include one or more physical, non-transitory, devices configured to hold data and/or instructions executable by logic subsystem 502 to implement the herein described methods and processes. When such methods and processes are implemented, the state of data-holding subsystem 504 may be transformed (e.g., to hold different data).

Data-holding subsystem 504 may include removable media and/or built-in devices. Data-holding subsystem 504 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 504 may include devices with one or more of the following characteristics: volatile, nonvolatile, dynamic, static, read/write, read-only, random access, sequential access, location addressable, file addressable, and content addressable. In some embodiments, logic subsystem 502 and data-holding subsystem 504 may be integrated into one or more common devices, such as an application specific integrated circuit or a system on a chip.

FIG. 5 also shows an aspect of the data-holding subsystem in the form of removable computer-readable storage media 510, which may be used to store and/or transfer data and/or instructions executable to implement the herein described methods and processes. Removable computer-readable storage media 510 may take the form of CDs, DVDs, HD-DVDs, Blu-Ray Discs, EEPROMs, and/or floppy disks, among others.

It is to be appreciated that data-holding subsystem 504 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

It is to be appreciated that a “service”, as used herein, may be an application program executable across multiple user sessions and available to one or more system components, programs, and/or other services. In some implementations, a service may run on a server responsive to a request from a client.

When included, display subsystem 506 may be used to present a visual representation of data held by data-holding subsystem 504. As the herein described methods and processes change the data held by the data-holding subsystem, and thus transform the state of the data-holding subsystem, the state of display subsystem 506 may likewise be transformed to visually represent changes in the underlying data. Display subsystem 506 may include one or more display devices utilizing virtually any type of technology. Such display devices may be combined with logic subsystem 502 and/or data-holding subsystem 504 in a shared enclosure, or such display devices may be peripheral display devices.

When included, communication subsystem 508 may be configured to communicatively couple computing system 500 with one or more other computing devices. Communication subsystem 508 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 500 to send and/or receive messages to and/or from other devices via a network such as the Internet.

It is to be understood that the configurations and/or approaches described herein are presented for the purpose of example, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device comprising a see-through display device, a method comprising:
recognizing, from image data received from an image sensor, a background scene of an environment viewable through the see-through display device, the environment comprising a physical object;
identifying one or more geometrical features of the physical object; and
displaying, on the see through display device, an image augmenting the one or more geometrical features.

2. The method of claim 1, wherein recognizing the background scene comprises:
receiving image data from the image sensor,
detecting one or more feature points in the environment from the image data, and
obtaining information regarding a layout of the environment based upon the one or more feature points;
wherein the one or more geometrical features are identified from the information regarding the layout.

3. The method of claim 2, further comprising determining a location of the see-through display device within the environment via the feature points.

4. The method of claim 2, wherein obtaining information regarding a layout of the environment comprises obtaining a surface map of the environment.

5. The method of claim 2, wherein identifying the one or more geometrical features comprises identifying, from the information regarding the layout of the environment and for each geometrical feature, one or more of a discontinuity associated with the geometrical feature and a gradient associated with the geometrical feature that exceeds a threshold gradient.

6. The method of claim 1, wherein displaying the image augmenting the one or more geometrical features comprises displaying highlights on the see-through display in spatial registration with one or more of an edge of an object and a corner of an object.

7. The method of claim 1, wherein recognizing the background scene comprises comparing an image of the background scene received from an image sensor to a previous image of the background scene and identifying a dynamic physical object that was not present in the previous background scene, and wherein the image further augments one or more geometrical features of the dynamic physical object.

8. The method of claim 1, wherein displaying the image augmenting the one or more geometrical features further comprises displaying a tag associated with the physical object.

9. The method of claim 8, further comprising acquiring an image of the background scene via an image sensor, and receiving a user input of the tag via a voice command.

10. The method of claim 1, further comprising displaying the image augmenting the one or more geometrical features of the displayed object if a brightness of ambient light is equal to or below a threshold ambient light level and/or upon receiving a user input requesting a low ambient light mode of the see-through display device.

11. The method of claim 1, further comprising an image illustrating navigational directions configured to direct a user through a space between objects.

12. A computing device, comprising:
a see-through display device;
an image sensor configured to acquire image data of a background scene viewable through the see-through display device;
a logic subsystem configured to execute instructions; and
a data-holding subsystem comprising instructions stored thereon that are executable by a logic subsystem to:
acquire an image of the background scene via the image sensor;
obtain data related to the background scene, the data comprising information regarding a layout of the environment based upon one or more feature points in the image of the background scene;
identify one or more edges of the physical object from the information regarding the layout; and
display, on the see through display device, an image augmenting an appearance of the one or more edges of the physical object.

13. The computing device of claim 12, wherein the image sensor comprises one or more color cameras.

14. The computing device of claim 12, wherein the image sensor comprises one or more depth cameras.

15. The computing device of claim 12, wherein the data related to the background scene is retrieved from a remote device over a computer network.

16. The computing device of claim 15, wherein the data related to the background scene comprises image data previously collected by a device other than the computing device.

17. The computing device of claim 15, wherein the image augmenting the one or more geometrical features comprises highlights displayed on the see-through display in spatial registration with one or more of an edge of an object and a corner of an object

18. On a wearable see-through display device, a method of augmenting an appearance of a low-light environment, the method comprising:
detecting a trigger to perform low-light augmentation;
acquiring an image of a background scene of an environment viewable through the see-through display device, the environment comprising one or more physical objects;
obtaining information related to a layout of the background scene, the data comprising a tag associated with a corresponding physical object;
displaying, on the see through display device, an image comprising a representation of the tag and also augmenting one or more geometrical features of the one or more physical objects by displaying highlighting of one or more of an edge of the physical object and a corner of the physical object in spatial registration with the physical object; and
updating the image as the user traverses the environment.

19. The method of claim 18, wherein updating the image as the user traverses the environment comprises generating a three-dimensional representation of a use environment comprising the background scene, tracking motion of the see through display device within the use environment, and updating the image based upon the tracking of the motion and the three-dimensional representation of the use environment.

20. The method of claim 18, wherein detecting a trigger to perform low-light augmentation comprises one or more of receiving a user input and detecting a brightness of ambient light that is equal to or below a threshold ambient light level, the user input comprising one or more of a voice command, a gesture, and actuation of an input mechanism.
